(19) United States
(12) Patent Application Publication
(10) Pub. No.: US 2022/0315862 A1
(43) Pub. Date: Oct. 6, 2022

(54) Impressed Candles

(71) Applicant: Stephen Ciottoni, Wynnewood, PA (US)

(72) Inventor: Stephen Ciottoni, Wynnewood, PA (US)

(21) Appl. No.: 17/219,368

(22) Filed: Mar. 31, 2021

(51) Int. Cl. C11C 5/02; G05D 23/19

(52) U.S. Cl. CPC C11C 5/021; G05D 23/1951; C11C 5/023

(57) ABSTRACT

The Impressed Candles apparatus incorporates an improved hand press function into an accessory that makes unique candle molds. An upper press defines a plurality of wax pour openings and an upper press plate having an upper portion of a plurality of wax molds each with a groove for a wick and a semi-round slot for a wick tab. A lower press includes a lower press plate having a respective lower portion of the plurality of wax molds each with a groove for the wick and a respective slot for the wick tab. A heat source in at least one of the upper press and the lower press is included with control electronics for powering and controlling the heat source including a temperature and a time duration for the temperature.

### BACKGROUND

Candles are a favored decorative item that provides lighting; yet, many have become outdated as individuals want to elevate their spaces by incorporating unique customized elements into their households. Specifically when traveling or celebrating a life milestone, a person may desire a unique memorabilia item that will serve as a special reminder of their experience. There have been no products available as original equipment or as an aftermarket to address this problem.

An apparatus to simplify the process of making a souvenir candle. With options to individualize your unique creation. That can be made in a souvenir shop or at home. There have been no products available as original equipment or as an aftermarket to address this problem either.

There exists a need for a device and a system for Impressed Candles that is not being met by any known or disclosed device or system of present.

### SUMMARY OF THE INVENTION

The Impressed Candles apparatus simplifies the process of making real-time candles for souvenir purposes. Introducing a modern candle making accessory that allows the user to personally engrave and implement candles with images that capture the vision, location or landmark of a particular memorable event. Made with quality materials, this candle press utilizes a hot scented wax base to mold a candle, of any shape or size, which is uniquely covered with images a user desires. One would simply select designed plates constructed to showcase a famous landmark, logo, picture, etc. arranged in a pattern able to emboss that image on each side of a candle as it molds into form. With its vertical design that allows was to be poured into molds, impressed Candles then permits the user to turn the device horizontal to safely open the press and remove the minted candle, once cooled and finished.

### BRIEF DESCRIPTION OF THE DRAWINGS

FIG. 1 is a front elevational view of the closed Impressed Candles apparatus in accordance with an embodiment of the present disclosure.

FIG. 2 is a front elevational view of the open Impressed Candles apparatus in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention. The term ‘engraving’ refers to anything a user impresses on a candle via the disclosure including images, writing, markings and even indents, protuberances and shapes.

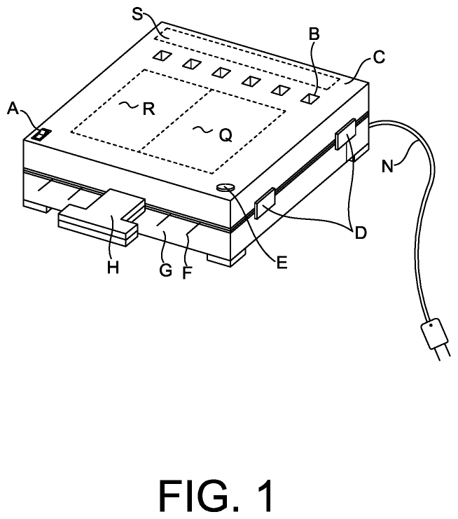

FIG. 1 is a top elevational view of the closed Impressed Candles apparatus showing the external view of the following: power button, slots to pour wax into chambers, top plate of press, latches, light heat indicator, wick, bottom plate of press, press handle, and the power cord in accordance with an embodiment of the present disclosure.

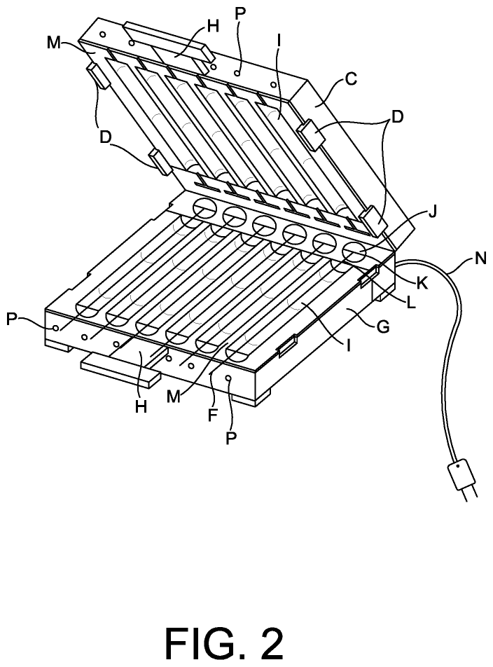

FIG. 2 is a top elevational view of the opened Impressed Candles apparatus showing the following: top plate of press, latches, wick, bottom plate of press, press handle, mold/wax chamber (Design Mold), sticking round tab attached to wick, slot to insert tab, groove for wick, removable plate of press, and power cord in accordance with an embodiment of the present disclosure.

The desired embossing plate should be chosen before plugging in the apparatus. It can be any size and/or shape of candle with imprinted, engraved, or embossed tiny vignettes of famous, recognizable, historic, renowned, buildings landmarks, or landscapes arranged in patterns on the candle (I.e. Independence hall, the liberty bell, the statue of liberty, the Washington monument, the colosseum, the leaning tower of Pisa, the Eiffel tower, Buckingham palace, the governor's mansion in Williamsburg, half dome in Yosemite park, etc.). These buildings or famous landscapes imprinted, engraved, or embossed on the candle numerous times around each side interchangeable press design sheet can be made to show one's personal effects such as a camp logo, own's initials, or a company logo.

Once the apparatus in plugged in, power turned on and reached the designated temperature. The operator pours in the desired wax (plain, colored, or scented). The apparatus is vertically during the pouring and pressing of the wax, to keep it pressed until it is finished. Once the desired time has passed then the apparatus is placed horizontally to open the press.

The Impressed Candle apparatus works almost like a hand press or waffle press. Instead of batter you fill the press with wax (colored, scented, or plain). The plates on the inside are carefully cut in a chosen design to mold the candle as you want. The plates on the inside will also be interchangeable to change out the shape of the vision you want pressed on the candle (i.e. a building, a holiday theme, or a name). I would also like for there to be an opportunity in the future to specially make press plates at the customers' request. Once the wax is heated and the plates emboss/mold the candle you let it cool and carefully remove the newly minted candle with your chosen design pressed into the candle.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A candle press comprising:
an upper press defining a plurality of wax pour openings and comprising an upper press plate having an upper portion of a plurality of wax molds each with a groove for a wick and a semi-round slot for a wick tab;
a lower press comprising a lower press plate having a respective lower portion of the plurality of wax molds each with a groove for the wick and a respective slot for the wick tab; and
a heat source in at least one of the upper press and the lower press and control electronics for powering and controlling the heat source including a temperature and a time duration for the temperature.

2. The candle press of claim 1, further comprising a set of latches on a side of the press for latching the upper press and the lower press in a complementary relation.

3. The candle press of claim 1, further comprising a handle for each of the upper press and the lower press, each handle disposed on a side opposite a set of hinges for the press.

4. The candle press of claim 1, further comprising a heat indicator on a top side of the upper press.

5. The candle press of claim 1, further comprising a slide configured to cover all the wax pour openings, the slide manipulatable from the upper press.

6. The candle press of claim 1, wherein the upper press plate and the lower press plates are removeable from the respective upper and lower press.

7. The candle press of claim 1, further comprising a lever latch on each side of the upper press to the lower press configured to apply a lever force to mating the sides.

8. The candle press of claim 1, further comprising a cooling source in one of the upper press and the lower press configured to accelerate a cooling of the press.

9. The candle press of claim 1, wherein the wax pour openings comprise a funnel shape to facilitate a wax flow therefrom into the respective wax molds.

10. The candle press of claim 1, further comprising a conventional taper candle mold in a combination of the upper press plate and the lower press plate.

11. The candle press of claim 1, further comprising a bell shaped candle mold in a combination of the upper press plate and the lower press plate.

12. The candle press of claim 1, further comprising an upper press plate design identical to a lower press plate design.

13. The candle press of claim 1, further comprising an upper press plate design complementary to a lower press plate design.

14. The candle press of claim 1, further comprising a mix and match upper press plate design and a lower press plate design.

15. The candle press of claim 1, further comprising an self-sealing overflow wax egress opening for each of the plurality of wax molds in the lower press and lower press plate which seals when heated based on a thermal expansion of a grommet thereof.

16. The candle press of claim 1, further comprising a programmable timer for a cooling of the wax in the wax molds via a dial and an electronic setting.

17. The candle press of claim 1, further comprising a vibration source in the candle press configured to vibrate air pockets out of the wax in the wax molds.

18. The candle press of claim 1, wherein the groove for the wick is defined adjacent an edge of the upper press and the lower press to center the wick in a candle.

19. The candle press of claim 1, wherein the respective slot for the wick tab is semicircular.

20. The candle press of claim 1, wherein the respective slot for the wick tab is semi-rectangular.
